(19) United States
(12) Patent Application Publication
(10) Pub. No.: US 2009/0097364 A1
(43) Pub. Date: Apr. 16, 2009

(54) HEAD SLIDER

(75) Inventors: Fumihiro Tawa, Kawasaki (JP); Wataru Odajima, Kawasaki (JP); Shinya Hasegawa, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/199,504

(22) Filed: Aug. 27, 2008

(30) Foreign Application Priority Data
Oct. 12, 2007 (JP) 2007-266098

(51) Int. Cl. G11B 11/00

(52) U.S. Cl. 369/13.17; G9B/21.003

(57) ABSTRACT

A head slider is used for magnetic record by irradiating a recording medium with tiny spots of light. The head slider includes a slider main body having a bottom surface facing a recording medium and a top surface opposite to the bottom surface, an optical head provided in the slider main body to irradiate the recording medium with light and an optical layer to propagate light supplied from outside and lead the light to the optical head. The optical layer is curved along a curved surface formed in a portion of the slider main body to form a curved propagation path of light.

### BACKGROUND OF THE INVENTION

1. Field of the Invention

The embodiments discussed herein are directed to a head slider of a magnetic recorder for magnetic recording by irradiating a recording medium with light of tiny spots.

2. Description of the Related Art

In a current magnetic disk apparatus, to increase storage capacity per unit of apparatus, a plurality of recording media is piled up on a rotation axis and a plurality of magnetic heads is used for recording/playback. To further increase storage capacity, it is necessary to increase storage capacity per recording medium by improving recording density in the recording medium. The recording method of a recording medium is shifting from the longitudinal recording method to the perpendicular recording method, further improving the recording density per recording medium. The crystal grain of a magnetic recording part in a recording material also tends to be continuously made finer.

As the crystal grain of the recording material is made finer, a problem such as disappearance of recorded information caused by the superparamagnetic effect may arise. The superparamagnetic effect causes a so-called thermal decay problem of media. The thermal assisted recording method is known as a method of solving this thermal decay problem. A recording material having strong coercivity at ordinary temperature is used in the thermal assisted recording method. In such a case, a write operation by a magnetic field from a write head element in the magnetic head is temporarily made easier by reducing coercivity through heating of a recording area of the recording medium while recording to thereby avoid disappearance of records at ordinary temperature. Laser light is generally used in the thermal assisted recording method to heat a recording medium in a noncontact fashion and thus, it is necessary to mount an optical head for irradiating the recording medium with light of tiny spots on a floating slider.

For such an optical head, a configuration in which a light source is mounted on a floating slider and that in which a light source is arranged outside a floating slider can be considered. Here, if a semiconductor laser is used as a light source, generation of heat accompanying excitation of laser light causes a problem. That is, heat generated by the semiconductor laser is given off to surroundings, leading to degradation of characteristics of a read head element and write head element of the magnetic head mounted on the floating slider. Thus, means for propagating luminous fluxes from the light source, which is arranged outside the floating slider, to the optical head of the floating slider is needed.

A technology to deflect gathered light and change the propagation direction to a recording medium by reflecting light propagating in parallel with the recording medium by a paraboloid has been proposed to couple the light propagating in parallel with the recording medium to an optical device on an end face of the floating slider (see, for example, Patent Document 1: Japanese Patent Application Laid-Open No. 60-224139). Also, a technology to deflect gathered light and change the propagation direction to a recording medium by reflecting light propagating in parallel with a recording medium by a paraboloid has been proposed (see, for example, Patent Document 2: Japanese Patent Application Laid-Open No. 2000-298802). Further, a technology to couple an optical fiber arranged in parallel with a recording medium to a grating after being reflected once by a mirror has been proposed (see, for example, Patent Document 3: Japanese Patent Application Laid-Open No. 2006-179169).

To realize thermal assisted recording by light, it is necessary to mount an optical head closer to a conventional magnetic head and also to supply a sufficient amount of light to the optical head in order to heat a recording medium. For this purpose, means for supplying light from the light source to the optical head at high efficiency is needed. Also, the optical head needs to meet environmental specifications similar to those of the magnetic head to apply thermal assisted recording by light to a conventional magnetic recording apparatus.

In Patent Document 1 described above, an optical fiber is coupled to an optical head by bending the optical fiber by 90 degrees on a rear surface of the floating slider. The optical fiber is constituted by a core and clad and a difference in the refractive index between the core and the clad is several %. Thus, there is a problem that a locked-in effect of light is weak and a propagation loss of light amount by bending is large. Moreover, even if the loss is permissible, the bending radius must be several tens of mm or more to bend the optical fiber in such a way that the core thereof is not broken. However, a plurality of recording media is piled up on a rotation axis in a current magnetic disk apparatus to increase recording capacity of the apparatus. Since the interval between recording media is as small as several mm, it is difficult to arrange an optical fiber by bending it. Naturally, the optical fiber can be arranged if the number of recording media is reduced, but recording capacity is reduced by the number of reduced media and thus, an advantage of improved recording density by the thermal assisted recording method is offset.

In Patent Document 2 described above, a paraboloid mirror is provided on a top surface of a floating slider, the paraboloid mirror is irradiated with a parallel light in a free space, and gathered light and light are deflected by 90 degrees by reflection. With this configuration, the structure of the floating slider itself must be changed. Moreover, the structure cannot maintain stable floating of the slider due to air resistance of the paraboloid mirror. Further, while the paraboloid mirror has an advantage of not being affected by problems such as wavelength fluctuations of the light source, light cannot be gathered to a focal position of the paraboloid mirror unless light completely in parallel with the optical axis is incident. Therefore, it is very difficult to supply a parallel light to the floating slider because the floating slider moves on the recording medium by swing driving of an arm and fluctuations of an incidence angle arise.

In Patent Document 3 described above, the rear surface of a floating slider is irradiated with light emitted from an optical fiber arranged in parallel with the top surface of the floating slider and a recording medium by mirror reflection before being coupled by a grating present on the rear surface of the slider to realize deflection of 90 degrees. The grating has a two-dimensional structure and thus, can be advantageously produced by a process similar to that for producing other magnetic heads and also coupled to a thin core. However, the grating has shortcomings of being vulnerable to wavelength fluctuations and incidence angle fluctuations. A laser diode (LD) is currently being examined as a light source to be mounted in a magnetic recording apparatus. Wavelength fluctuations are caused by an operating temperature and individual LDs have variations in the excitation wavelength. Thus, fine tuning of the incidence angle is needed for each optical head and an environmental temperature of the LD must be controlled. Like Patent Document 2, the incidence angle may fluctuate due to swing driving of an arm and thus, there is a problem that, due to reflection by a mirror, it is difficult to adjust or guarantee the incidence angle.

An object of the present invention is to provide a head slider capable of guiding light to an optical head by forming a curved propagation path in the head slider.

### SUMMARY

In accordance with an aspect of embodiments, a head slider includes a slider main body having a bottom surface facing a recording medium and a top surface opposite to the bottom surface, an optical head provided in the slider main body to irradiate the recording medium with light and an optical layer to propagate light supplied from outside and direct the light to the optical head. The optical layer is curved along a surface formed in a portion of the slider main body to form a curved propagation path for light.

### BRIEF DESCRIPTION OF THE DRAWINGS

FIG. 1 is a sectional view of a head slider according to a first embodiment of the present invention;

FIG. 2 is a perspective view of the head slider according to the first embodiment of the present invention;

FIG. 3 is a sectional view of an optical layer;

FIG. 4 is a sectional view of the optical layer having a core layer in a multilayer structure;

FIG. 5 is a sectional view of the optical layer having a light gathering function;

FIG. 6 is a sectional view of an optical waveguide;

FIG. 7A and FIG. 7B are sectional views of an optical layer for illustrating a formation method of the optical layer;

FIG. 8 is a perspective view of a head slider according to a second embodiment of the present invention;

FIG. 9 is a cross section for illustrating a processing method of forming a groove in a slider main body;

FIG. 10 is a sectional view of a head slider according to a third embodiment of the present invention;

FIG. 11 is a sectional view of a head slider according to a fourth embodiment of the present invention;

FIG. 12 is a sectional view of a head slider according to a fifth embodiment of the present invention;

FIG. 13 is a sectional view of a head slider according to a sixth embodiment of the present invention;

FIG. 14 is a sectional view of a head slider according to a seventh embodiment of the present invention; and

FIG. 15 is a perspective view of the head slider according to the seventh embodiment of the present invention.

### DETAILED DESCRIPTION OF THE EMBODIMENTS

Embodiments of the present invention will be described with reference to the drawings.

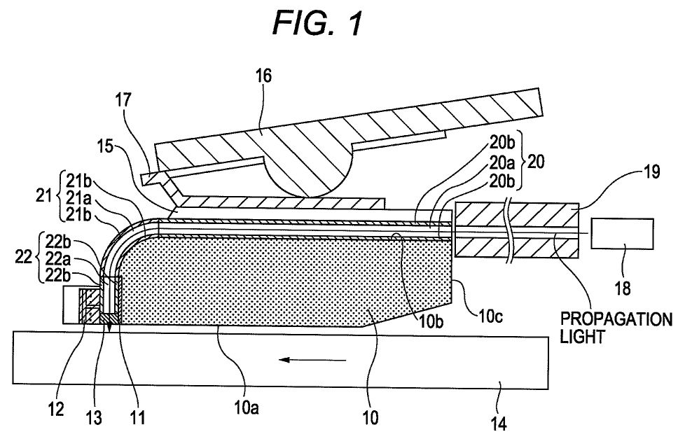

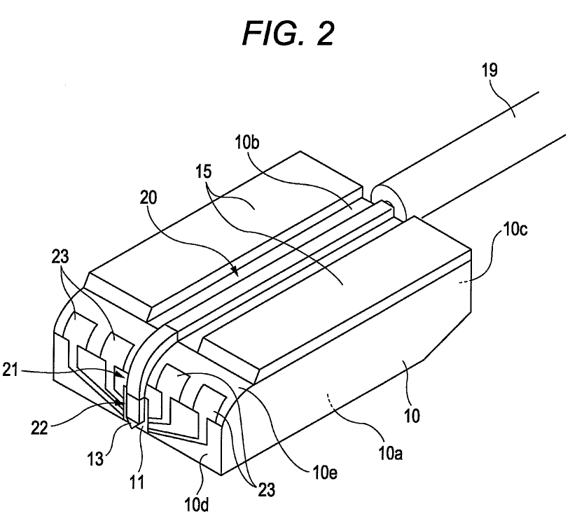

First, a head slider according to a first embodiment of the present invention will be described with reference to FIG. 1 and FIG. 2. FIG. 1 is a sectional view of the head slider according to the first embodiment of the present invention. FIG. 2 is a perspective view of the head slider according to the first embodiment of the present invention.

The head slider shown in FIG. 1 has a slider main body 10, a read head element 11, a write head element 12, and an optical head 13. The head slider in the present embodiment is a head slider for thermal assisted magnetic recording/playback. The read head element 11 is made of a magneto-resistive device such as a GMR (giant magneto-resistive effect element) and TMR (tunneling magneto-resistive effect element). The write head element 12 is constituted by an inductive coil and a yoke. The optical head 13 is provided to vertically irradiate a recording medium 14 such as a magnetic disk with light to locally heat the recording medium 14.

The slider main body 10 has a bottom surface 10a forming an air bearing surface (ABS) opposite to the recording medium 14 and floating over the recording medium 14 and a top surface 10b on the opposite side of the bottom surface 10a. A front surface 10c and a rear surface 10d extend between the bottom surface 10a and the top surface 10b. A magnetic head is constituted by the read head element 11 and the write head element 12. The read head element 11, the write head element 12, and the optical head 13 are formed on the bottom surface 10a side of the rear surface 10d of the slider main body 10.

Two filling plates 15 as gimbal mounting members are affixed to the top surface 10b of the slider main body 10. With a gimbal 17 mounted on a head suspension 16 being fixed by the filling plates 15, the head slider is supported by the head suspension 16 via the gimbal 17. The head slider receives an uplifting force caused by an air stream accompanying rotation of the recording medium 14 while being supported by the head suspension 16 to perform a recording or playback operation floating over the recording medium 14.

In the present embodiment, the optical head 13 has a function of a lens to gather and project light on a recording surface of the recording medium 14. Light supplied to the optical head 13 is supplied through an optical waveguide 20 provided on the top surface 10b of the slider main body 10 from a light source 18 arranged outside the head slider such as a laser diode via an optical fiber 19. The optical waveguide 20 extends from the front surface 10c side to the rear surface 10d side along the top surface 10b of the slider main body 10 and has a structure in which a clad layer 20b is provided around a core layer 20a.

In the present embodiment, a portion where the top surface 10b and the rear surface 10d of the slider main body 10 intersect is formed as a curved surface 10e. One end of the curved surface 10e is smoothly connected to the top surface 10b and the other end side is smoothly connected to the rear surface 10d of the slider main body 10. Here, the rear surface 10d corresponds to a surface of the read head element 11 (or a material layer for forming the read head element 11) formed so as to be embedded in the slider main body 10.

The optical head 13 is formed on the rear surface 10d of a corner where the rear surface 10d and the bottom surface 10a intersect and is connected to an optical waveguide 22 similarly formed on the rear surface 10d. The optical waveguide 22 also has a structure in which a clad layer 22b is provided around a core layer 22a.

Here, in the present embodiment, an optical layer 21 is formed along the curved surface 10e of the slider 10. One end (an opening or a plane of incidence) of the optical layer 21 is connected to the optical waveguide 20 provided on the top surface 10b of the slider 10 and the other end (an opening for emission or a plane of emission) is connected to the optical waveguide 22 formed on the rear surface 10d. Like the optical waveguides 20/22, the optical layer 21 is made of a core layer 21a to be an optical path where light propagates and a clad layer 21b formed so as to surround the core layer 21a.

Light supplied to the optical waveguide 20 from the light source 18 via the optical fiber 19 propagates through the core layer 20a of the optical waveguide 20 before being incident on the core layer 21a of the optical layer 21. After entering the optical layer 21, the propagation direction of the light is bent by 90 degrees by being propagated through the curved core layer 21a before being incident on the core layer 22a of the optical waveguide 22. Then, the light is introduced from the optical waveguide 22 into the optical head 13 and gathered by the optical head 13 before being irradiated on the recording medium 14.

Incidentally, an electrode 23 for the magnetic read head element 11 and the magnetic write head element 12 is formed on the curved surface 10e of the slider main body 10. Electricity can be supplied to the magnetic write head element 12 via the electrode 23 and also an electric signal from the magnetic read head element 11 can be transmitted to the outside via the electrode 23.

In the present embodiment, as described above, the curved surface 10e is provided on the slider 10 and the optical layer 21 is provided along the curved surface 10e and thus, an optical path can be curved along the slider main body 10 and the propagation direction of light from the outside light source 18 can be curved. Therefore, even if the optical axis of the outside light source 18 and that of the optical head 13 are different by 90 degrees, light from the outside light source 18 can be fed to the optical head 13 without using an optical fiber or reflector.

The structure forming the optical path is provided, as described above, near the top surface 10b and the rear surface 10d of the slider main body. Therefore, there is no need to provide a large space around the head slider to provide a structure for introducing light into the optical head 13, and the thickness of the head slider including a structure for forming an optical path can be reduced. Accordingly, if recording media are provided by being piled up, the interval between recording media can be made smaller so that the number of recording media that can be provided in a recording apparatus of the same size can be increased correspondingly. As a result, storage capacity per unit volume of the recording apparatus can be increased.

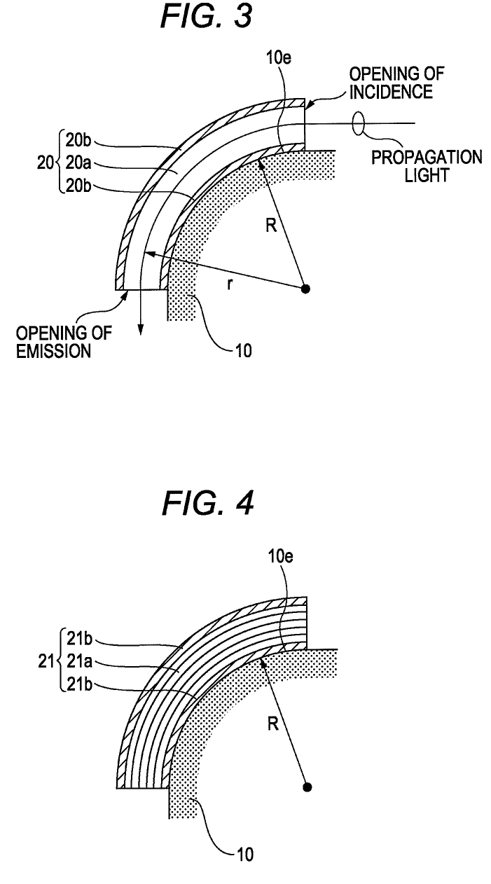

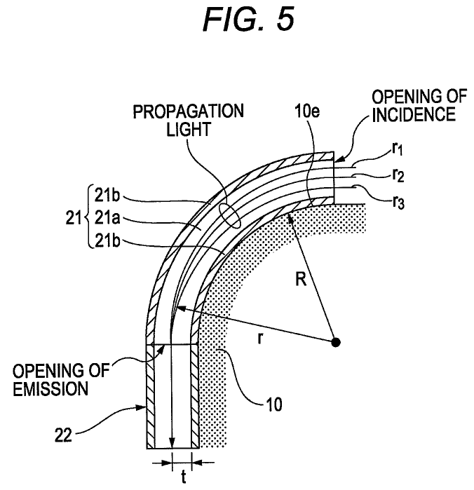

Here, the optical layer 21 will be described in more detail. FIG. 3 is an enlarged sectional view of the optical layer 21. The core layer 21a of the optical layer 21 in the present embodiment has the distribution of refractive index expressed by the following formula in relations of variables shown in FIG. 3

nr=n0·R/r (1)

In Formula (1), nr is the refractive index at a position of a curvature radius r in the optical layer, and n0 is the refractive index at a position of a curvature radius R of the core layer 21a of the optical layer 21 formed on the curved surface 10e of the head slider. In the distribution of refractive index expressed by Formula (1), the refractive index nr becomes smaller with the increasing curvature radius r. That is, the refractive index nr of the core layer 21a becomes smaller with the increasing curvature radius r. If the distribution of refractive index expressed by Formula (1) is adopted, a wave surface of light incident on the core layer 21a of the optical layer 21 becomes a wave surface matching the direction of the curvature radius R, resulting in a curved optical path along the curved surface 10e. Also, such distribution of refractive index is similar to propagation in a free space and provides properties such as reflection of the position, inclination and the like of incident light to an opening of incidence (plane of incidence) in emitting light from an opening of emission (plane of emission).

Next, the method of manufacturing a head slider according to the present invention will be described. In the manufacturing process of head sliders according to the present invention, like the head of a general magnetic recording/playback apparatus, devices such as the read head element 11, the optical head 13, the write head element 12, the optical waveguide 20, and the electrode 23 are produced by lithography technology in an area on the substrate corresponding to the rear surface 10d not covered by the curved surface 10e of the slider main body 10 and then, a film to protect these devices is formed. Then, after head sliders are cut out like an extending bar, the bar of the head slider is polished as a curved surface similarly to chamfering of machining to thereby form the curved surface 10e of the slider main body 10. An optical layer on the curved surface 10e can be formed by a film formation method using the etching method or liftoff method of lithography technology. A film to extend the electrode 23 of the read head element 11 and the write head element 12 is formed on the curved surface 10e. Then, the optical waveguide 20 is formed on the top surface 10b of the slider main body 10 by lithography technology. Like a conventional head slider, the bottom surface (air bearing surface) is processed and then, head sliders are individually cut out. Then, the filling plates 15 are mounted on the top surface 10b of the slider main body 10 and the filling plates 15 and the gimbal 17 are bonded. Lastly, the electrode 23 of the head slider and a wiring circuit substrate for the magnetic head mounted on the head suspension are electrically connected by wire bonding or the like. The length of bonding wire can be made shorter by forming the electrode 23 on the curved surface 10e.

Next, an example of the film formation method of the optical layer 21 having the distribution of refractive index described above will be described. The core of a two-dimensional optical head used for thermal assisted recording is formed from materials, for example, high refractive index materials such as TiO₂ and Ta₂O₅. To reduce bonding losses between the optical layer 21 and the optical waveguides 20/22, it is preferable, for example, to make the refractive index of the core layers 20a/22a of the optical waveguides 20/22 and that of the refractive index of the core layer 21a of the optical layer 21 equal.

Then, for example, if the wavelength of incident light is 660 nm and the core material of the optical waveguide is Ta₂O₅ (n=2.11), the curvature radius R of the curved surface 10e is 100 μm, the thickness of the optical layer 21 is 5 μm, and the material at the position of the curvature radius R has the same refractive index as Ta₂O₅, the distribution of refractive index in the core layer 21a of the optical layer 21 will be 2.11 to 2.01. If a portion corresponding to half the thickness of the optical layer 21 has the same refractive index as Ta₂O₅, the distribution of refractive index in the core layer 21a of the optical layer 21 will be 2.26 to 2.06.

It is preferable that the refractive index in the core layer 21a of the optical layer 21 continuously change in the direction of curvature radius. As a method of forming the core layer 21a having a continuously changing refractive index, for example, a high-frequency sputtering film formation method using two materials of high refractive index material and low refractive index material is known.

The refractive index of the core layer 21a of the optical layer 21 structured as described above changes in the direction of curvature radius so that the phase of propagating light leads in a portion of the curvature radius smaller than the radius at a predetermined position in the core layer 21a intended to be a propagation path of light, and the phase of propagating light lags in a portion of the curvature radius larger than that at the predetermined position. Then, the wave surface in the direction of curvature radius of light emitted in the opening of emission (plane of emission) of the core layer 21a will be like an arc.

Sometimes it is difficult to control the process so that the refractive index continuously changes. As shown in FIG. 4, a method of using multiple layers as the core layer 21a is also known, in which dummy distribution of refractive index is provided by making the refractive index in the same layer uniform. For example, if the thickness of a layer in which Ta₂O₅ and SiO₂ are combined is ¼ or less of the effective wavelength in the optical layer 21, the material is considered to be almost the same regarding reaction of light. Then, by sequentially changing the mixing ratio of Ta₂O₅ and SiO₂ in the direction of curvature radius in each layer of layers combining Ta₂O₅ and SiO₂, the refractive index can be changed in the direction of curvature radius. As a film formation apparatus for generating such a multilayer, an ion plating apparatus used for lamination of two materials in several tens of layers such as an antireflection film can be used.

When the optical waveguides 20/22 of a head slider are formed, it is preferable to use an ion plating apparatus capable of forming a film having excellent optical characteristics. Since the filling plates 15 are bonded to the head slider and gimbal, an organic or metallic adhesive or a rigid material to which an adhesive is applied may be used as the filling plates 15.

By providing the distribution of refractive index expressed by Formula 2, Formula 3, and Formula 4 shown below in the core layer 21a of the optical layer 21, a light gathering function can be added to the optical layer 21.

nr1<n0·R/r1 (2)

nt=n0.R/(R+t) (3)

nr2>n0·R/r2 (4)

In the above formulas, r1, r2, and r3 represent curvature radii in the opening of incidence (plane of incidence) and are related by r1>r2>r3. nt represents the refractive index when the optical axis height in the opening of emission (plane of emission) is t and the curvature radius is at a position of r=R+t. nr1 represents the refractive index in the range of R<r1<R+t and nr2 represents the refractive index in the range of R+t<r2<R+2t. By adjusting the distribution of refractive index in the core layer 21a of the optical layer 21, as described above, light incident on the opening of incidence (plane of incidence) can be made convergent light as if gathered by a lens in the opening of emission (plane of emission). Using the light gathering function, for example, light diverged from the optical fiber 19 can be introduced into the optical waveguide 22 mounted on the rear surface 10d of the head slider.

The optical head 13 mounted on the rear surface 10d of the head slider generally has a size of millimeters or less. Thus, the core layer 22a of the optical waveguide 22 mounted on the rear surface 10d of the head slider is a very thin film. It is therefore possible to replace a conventional light gathering optical system using a lens by the optical layer 21 having a light gathering lens effect based on the distribution of refractive index. A light gathering function can thereby be obtained without providing a complex light gathering lens system.

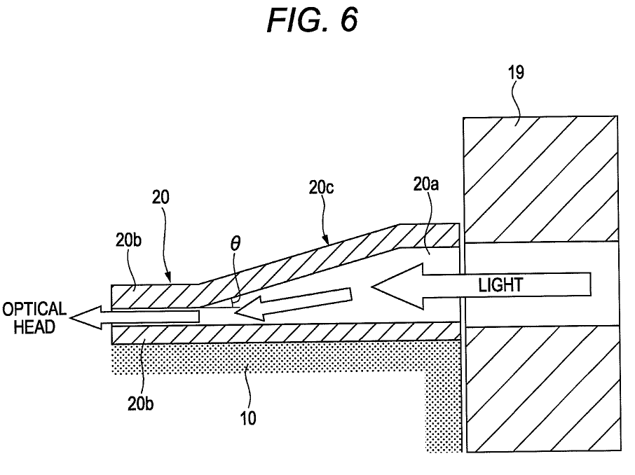

The optical head 13 provided on the rear surface 10d of the head slider generally has a size of millimeters or less. Thus, the core layer 22a of the optical waveguide 22 provided on the rear surface 10d of the head slider is very thin. On the other hand, the core of an optical fiber supplying light from an external light source has a size of millimeters. Thus, for example, as shown in FIG. 6, bonding of the optical fiber 19 and the optical waveguide 20 by adopting a taper structure for a portion of the optical waveguide 20 can be considered. A taper angle θ in the taper structure is preferably a tiny angle to minimize a mode conversion loss. However, it is very difficult to provide a tiny angle (taper angle θ) in the core layer 20a of the optical waveguide 20.

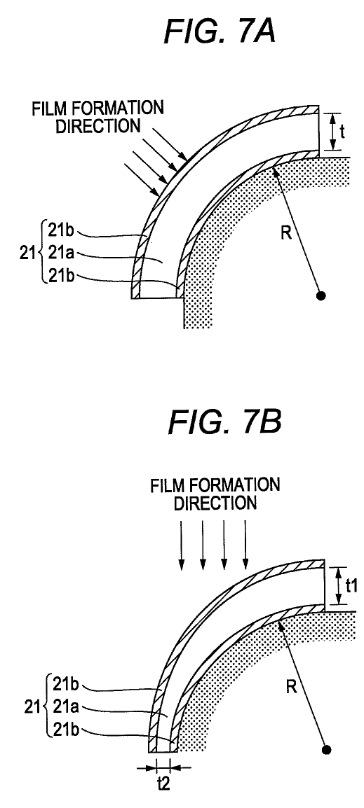

Accordingly, the taper structure can be formed on a curved surface by using the above optical layer 21. The method of manufacturing the optical layer 21 having a taper structure formed on a curved surface will be described below. First, as shown in FIG. 7A, the clad 21b and the core layer 21a are formed by rotating around the center of curvature of the curved surface 10e of the slider main body 10 to form the optical layer 21 having no taper structure (the optical layer 21 shown in FIG. 1). That is, the curved surface 10e is rotated or reciprocatingly turned with respect to the film formation direction so that the amount of deposition of the material of the core layer 21a is equal at any position of the curved surface 10e by making the time at which any position of the curved surface 10e is directed toward the film formation direction equal. The optical layer 21 having a uniform thickness t can thereby be formed on the curved surface 10e.

On the other hand, as shown in FIG. 7B, the thickness of the core layer 21a can be changed along the curved surface 10e by fixing the curved surface 10e with respect to the film formation direction. In the example shown in FIG. 7B, the core layer 21a is formed in such a way that the film formation direction of the core layer 21a is almost parallel to the extending direction of the rear surface 10d connected to the curved surface 10e. Accordingly, the thickness of a portion of the curved surface 10e close to perpendicular to the film formation direction becomes thicker and that of a portion close to parallel to the film formation direction becomes thinner. That is, a thickness t1 on the opening of incidence (plane of incidence) side of the optical layer 21 (core layer 21a) is large and gradually decreases toward the opening of emission (plane of emission), where the thickness is a thickness t2. The method of forming the optical layer 21 (core layer 21a) that is tapered and curved is not limited to the one by which the curved surface 10e is fixed with respect to the film formation direction, and the ratio of decrease in thickness can be changed by rotating or turning the curved surface in such a way that the opening side of incidence of the curved surface 10e remains perpendicular to the film direction for a longer time than the opening side of emission of the curved surface 10e. In this manner, the thickness of the optical layer 21 can be controlled by relatively changing the film formation direction and the position of the curved surface 10e.

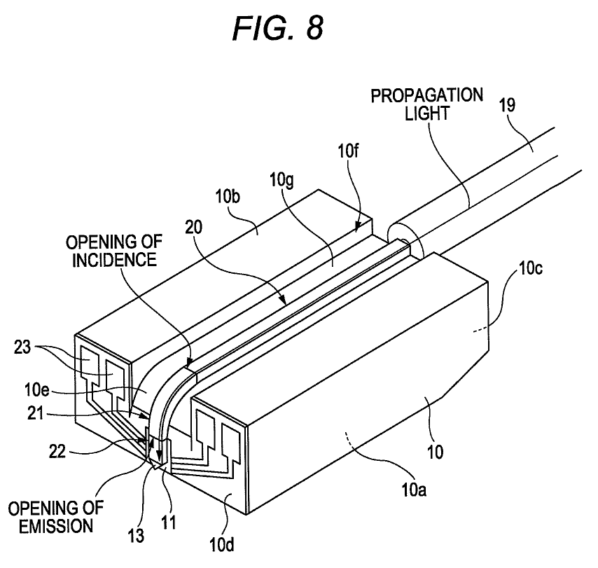

Next, the head slider according to the second embodiment of the present invention will be described with reference to FIG. 8. FIG. 8 is a perspective view of the head slider according to the second embodiment of the present invention. In FIG. 8, the same reference numerals are attached to components equivalent to those shown in FIG. 1 or FIG. 2 and a description thereof is omitted.

The head slider in the present embodiment has basically the same configuration as that of the head slider shown in FIG. 1, but is different from the head slider shown in FIG. 1 in that a groove 10f is provided on the top surface 10b of the slider main body 10. The groove 10f extends in the center portion of the top surface 10b from the front surface 10c to the rear surface 10d. The curved surface 10e is formed between a bottom surface 10g of the groove 10f and the rear surface 10d. The optical waveguide 20 is formed on the groove bottom surface 10g of the groove 10f and is connected to the optical layer 21 formed on the curved surface 10e.

The head slider in the present embodiment is not provided with the filling plates 15, and the gimbal 17 (not shown) is directly bonded to the top surface 10b of the slider main body 10. That is, in the present embodiment, a space for providing the optical waveguide 20 is secured by forming the groove 10f on the top surface 10b of the slider main body 10, instead of affixing the two filling plates 15 to the top surface 10b and providing the optical waveguide 20 in a space therebetween.

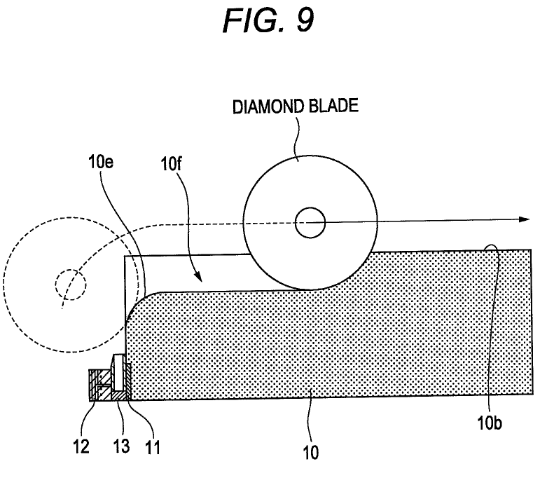

As shown in FIG. 9, the groove 10f can easily be formed by cutting the slider main body 10 using a cutting tool such as a diamond blade. At this point, the curved surface 10e can also be formed simultaneously with the groove 10f. The width of the groove 10f is, for example, about 50 μm and by using a diamond blade whose width is 50 μm, the groove 10f having the width of 50 μm can easily be formed. The groove 10f only needs to have a depth that is deeper than the height of the optical waveguide 20 formed on the groove bottom surface 10g of the groove 10f.

The head slider in the present embodiment does not need the filling plates 15 for bonding the slider main body 10 to the gimbal 17 so that the number of components can be reduced. The head slider in the present embodiment also has an advantage that the electrode 23 for the read head element 11 and the write head element 12 can be arranged almost at the same position as before.

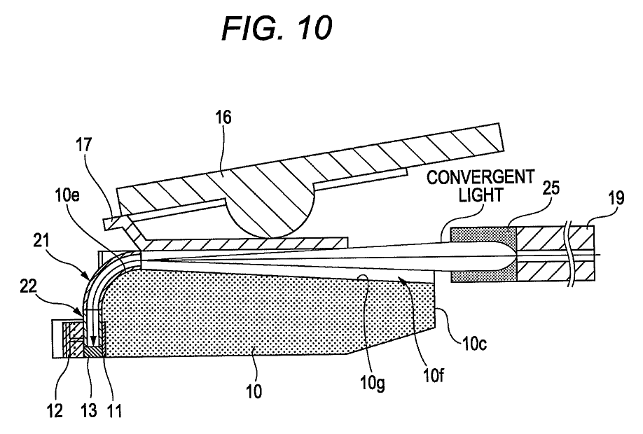

Next, the head slider according to the third embodiment of the present invention will be described with reference to FIG. 10. FIG. 10 is a sectional view of the head slider according to the third embodiment of the present invention. In FIG. 10, the same reference numerals are attached to components equivalent to those shown in FIG. 8.

The head slider according to the present embodiment has the groove bottom surface 10g inclined so that the groove 10f becomes deeper on the front surface 10c side. Also, the optical waveguide 20 is not provided on the groove bottom surface 10g and the inside of the groove 10f is a space. Moreover, the opening of incidence (plane of incidence) of the optical layer 21 is exposed in a portion where the groove bottom surface 10g is connected to the curved surface 10e.

In the head slider having the configuration described above, convergent light by a rod lens 25 is directly supplied to the opening of incidence (plane of incidence) of the optical layer 21. That is, as shown in FIG. 10, the rod lens 25 is mounted at the tip of the optical fiber 19 and convergent light emitted from the rod lens 25 passes through a space inside the groove 10f before being incident on the optical layer 21. Light emitted from the rod lens 25 has a large beam diameter because the rod lens 25 causes light to converge after diverging the light once. Thus, the groove 10f near the rod lens 25 is made deeper (the groove bottom surface 10g is made an inclined plane) so that light passing through the space inside the groove 10f should not come into contact with the groove bottom surface 10g.

According to the present embodiment, there is no need to provide the optical waveguide 20 on the top surface 10b of the head slider so that reduction of the amount of light due to optical mode (noise) generated inside the optical waveguide 20 can be prevented. Accordingly, the amount of light supplied to the optical head 13 can be increased.

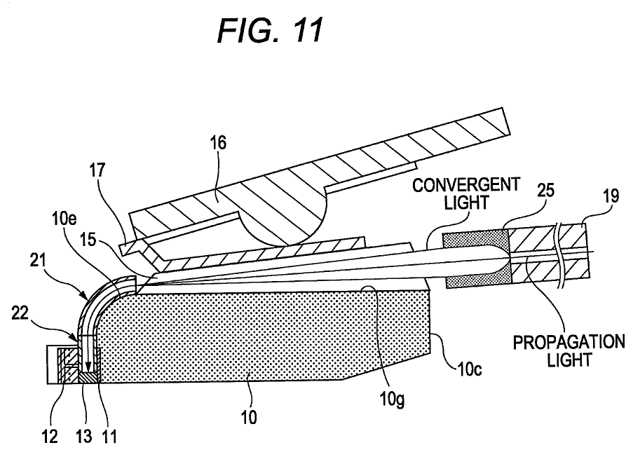

Next, the head slider according to the fourth embodiment of the present invention will be described with reference to FIG. 11. FIG. 11 is a sectional view of the head slider according to the fourth embodiment of the present invention. In FIG. 11, the same reference numerals are attached to components equivalent to those shown in FIG. 8.

Like the head slider shown in FIG. 1, the head slider according to the present embodiment has the two filling plates 15 for bonding the gimbal 17 to the top surface 10b of the slider main body 10. The optical waveguide 20 is not provided on the top surface 10b of the slider 10 and the opening of incidence (plane of incidence) of the optical layer 21 is exposed in a portion where the top surface 10b is connected to the curved surface 10e.

In the head slider having the configuration described above, convergent light by the rod lens 25 is directly supplied to the opening of incidence (plane of incidence) of the optical layer 21. That is, as shown in FIG. 11, the rod lens 25 is mounted at the tip of the optical fiber 19 and convergent light emitted from the rod lens 25 passes through a space between the filling plates 15 before being incident on the optical layer 21. Light emitted from the rod lens 25 has a large beam diameter because the rod lens 25 causes light to converge after diverging the light once. Thus, the optical axis of the rod lens 25 is slightly inclined with respect to the top surface 10b so that convergent light emitted from the rod lens 25 should not come into contact with the top surface 10b of the slider main body 10. The top surface of the filling plates 15, that is, the surface to which the gimbal 17 is bonded is also inclined so that convergent light should not come into contact with the gimbal 17.

According to the present embodiment, there is no need to provide the optical waveguide 20 on the top surface 10b of the head slider so that reduction of the amount of light due to optical mode (noise) generated inside the optical waveguide 20 can be prevented. Accordingly, the amount of light supplied to the optical head 13 can be increased.

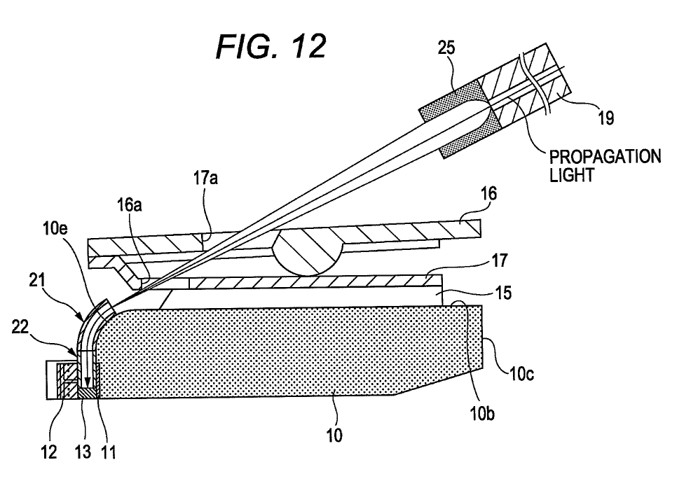

Next, the head slider according to the fifth embodiment of the present invention will be described with reference to FIG. 12. FIG. 12 is a sectional view of the head slider according to the fifth embodiment of the present invention. In FIG. 12, the same reference numerals are attached to components equivalent to those shown in FIG. 10.

Like the head slider shown in FIG. 1, the head slider according to the present embodiment has the two filling plates 15 for bonding the gimbal 17 to the top surface 10b of the slider main body 10. The optical waveguide 20 is not provided on the top surface 10b of the slider 10. The optical layer 21 is formed halfway through the curved surface 10e and the opening of incidence (plane of incidence) of the optical layer 21 is inclined.

The rod lens 25 is arranged above the head suspension 16 and the gimbal 17 and convergent light emitted from the rod lens 25 passes through a through hole 16a provided in the head suspension and a through hole 17a provided in the gimbal 17 before being incident on the opening of incidence of the optical layer 21.

According to the present embodiment, there is no need to provide the optical waveguide 20 on the top surface 10b of the head slider so that reduction of the amount of light due to optical mode (noise) generated inside the optical waveguide 20 can be prevented. Accordingly, the amount of light supplied to the optical head 13 can be increased.

The slider main body 10 is fixed to the gimbal 17 via the filling plates 15 in the present embodiment, but like other embodiments, a groove may be formed on the top surface 10b of the slider main body 10 to directly bond the gimbal 17 to the top surface 10b.

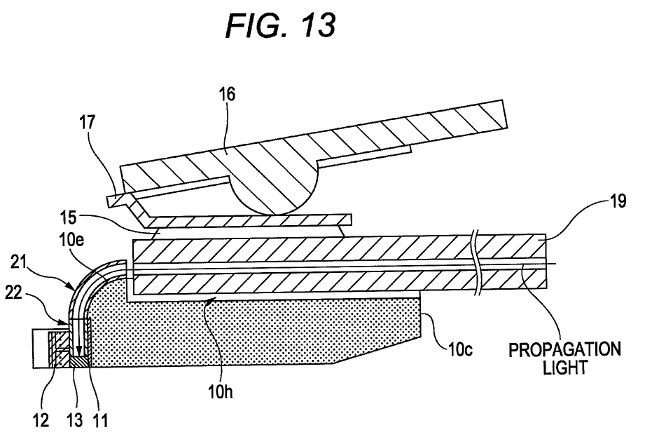

Next, the head slider according to the sixth embodiment of the present invention will be described with reference to FIG. 13. FIG. 13 is a sectional view of the head slider according to the sixth embodiment of the present invention. In FIG. 13, the same reference numerals are attached to components equivalent to those shown in FIG. 1.

In the present embodiment, a V groove 10h is formed on the top surface 10b of the slider main body 10 of the head slider shown in FIG. 1 and the optical fiber 19 is fixed to the V groove 10h. That is, the optical fiber 19 can be fixed to the slider main body 10 and also the optical axis of the optical fiber 19 can be fitted to the opening of incidence of the optical layer 21 by mounting the optical fiber 19 while being sandwiched between two inside surfaces of the V groove 10h.

According to the present embodiment, there is no need to provide the optical waveguide 20 on the top surface 10b of the head slider so that reduction of the amount of light due to optical mode (noise) generated inside the optical waveguide 20 can be prevented. Accordingly, the amount of light supplied to the optical head 13 can be increased.

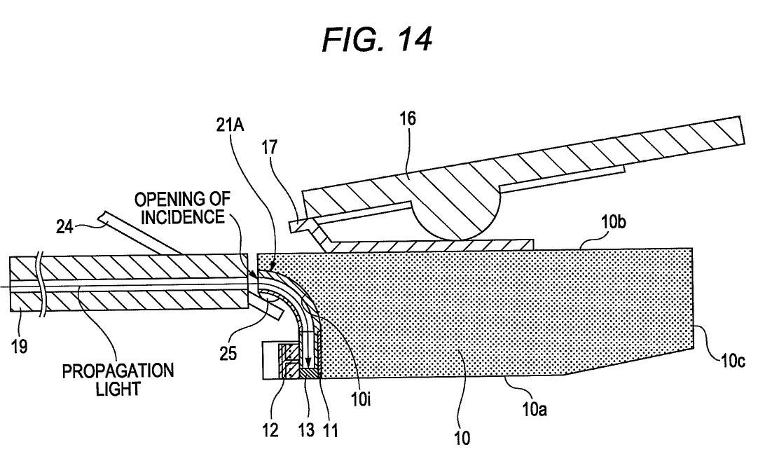

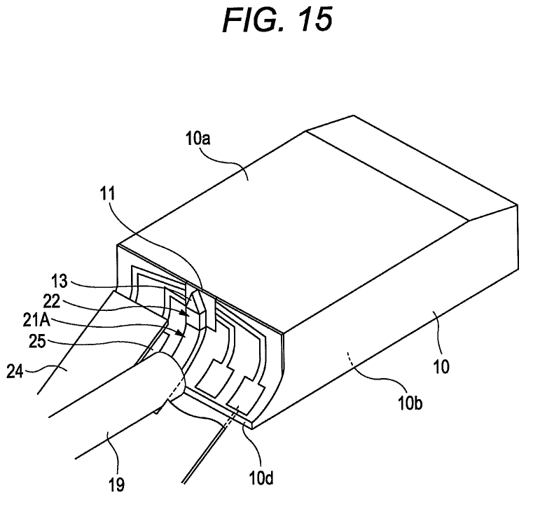

Next, the head slider according to the seventh embodiment of the present invention will be described with reference to FIG. 14 and FIG. 15. FIG. 14 is a sectional view of the head slider according to the seventh embodiment of the present invention. FIG. 15 is a perspective view of the head slider according to the seventh embodiment of the present invention viewed from the bottom side. In FIG. 14 and FIG. 15, the same reference numerals are attached to components equivalent to those shown in FIG. 1 and FIG. 2.

In the present embodiment, in contrast to the head sliders in the above embodiments, a concave curved surface 10i is formed on the rear surface 10d side of the slider main body 10 as a curved surface and an optical layer 21A is formed on the concave curved surface 10i. The optical layer 21A has a constitution similar to that of the optical layer 21 in the above embodiments and is different only in that the optical layer 21A is formed on the concave curved surface 10i, instead of the convex curved surface 10e.

The concave curved surface 10i terminates at the end surface of the slider main body 10 and thus, the optical layer 21A also terminates at the end surface of the slider main body 10 and a terminated portion becomes an opening of incidence (plane of incidence). Therefore, the optical fiber 19 is arranged on the side opposite to that in the above embodiments, that is, on the rear surface 10d side of the slider main body 10 and light emitted from the optical fiber 19 is directly incident on the opening of incidence (plane of incidence) of the optical layer 21A.

Also, as shown in FIG. 15, the electrode 23 of the read head element 11 and the write head element 12 is formed on the concave curved surface 10i. FIG. 15 is a diagram of the head slider when viewed from the bottom surface 10a side of the slider main body 10, turning the head slider shown in FIG. 14 upside down. A circuit board 24 for magnetic head control and the electrode 23 are electrically connected by ball bonding. That is, electrical connection is achieved by inserting a tiny conductive ball electrode 25 (for example, a gold ball) between an electrode pad (not shown) provided at an edge of the circuit board 24 and the electrode 23 and compressing the ball electrode 25. The circuit board 24 and the gimbal 17 are integrated or in close contact and the concave curved surface 10i is sandwiched by stresses of the circuit board 24 and the gimbal 17 so that poor connection between the electrode 23 and the circuit board 24 can be reduced.

In the present embodiment, the optical layer 21A is formed on the concave curved surface 10i. Thus, in contrast to the other embodiments, the distribution of refractive index is such that the refractive index is small on the concave curved surface 10i side of the optical layer 21A and becomes larger with a decreasing curvature radius. Otherwise, the formation method of the optical layer 21A is the same as that of the optical layer 21 in other embodiments.

To form the concave curved surface 10i of the slider main body 10 of the head slider according to the present embodiment, a substrate such as a wafer on which a slider main body is to be formed is polished to form a groove structure having a flat bottom and a curved surface from the bottom to the substrate surface. Then, like the head of a general magnetic recording/playback apparatus, devices such as the read head element 11, the optical head 13, the write head element 12, and the optical waveguide 22 are produced by lithography technology at the flat bottom of the groove. Further, in contrast to the other embodiments, the optical layer 21A and the electrode 23 on the curved surface are all produced. The process thereafter is the same as the manufacturing process of a general head slider.

According to the present embodiment, the concave curved surface 10i is provided on the slider main body 10 and the optical layer 21A is formed along the curved surface 10i and thus, an optical path can be curved along the slider main body 10 and the propagation direction of light supplied from the optical fiber 19 can be curved. Therefore, even if the optical axis of light from the optical fiber 19 and that of the optical head 13 are different by 90 degrees, light from the optical fiber 19 can be fed to the optical head 13 without using an optical fiber or reflector.

The structure forming the optical path is provided, as described above, near the top surface 10b and the rear surface 10d of the slider main body. Therefore, there is no need to provide a large space around the head slider to provide a structure for introducing light into the optical head 13, and the thickness of the head slider including a structure for forming an optical path can be reduced. Accordingly, if recording media are provided by being piled up, the interval between the recording media can be made smaller so that the number of recording media that can be provided in a recording apparatus of the same size can be increased correspondingly. As a result, storage capacity per unit volume of the recording apparatus can be increased.

In addition to variations and modifications in the component parts and/or arrangements, alternative uses will also be apparent to those skilled in the art.

What is claimed is:

1. A head slider comprising:
a slider main body having a bottom surface facing a recording medium and a top surface opposite to the bottom surface;
an optical head provided in the slider main body to irradiate the recording medium with light; and
an optical layer to propagate light supplied from outside and lead the light to the optical head, wherein
the optical layer is curved along a curved surface formed in a portion of the slider main body to form a curved propagation path of light.

2. The head slider according to claim 1, wherein
a refractive index of the optical layer changes in a direction of a curvature radius of the propagation path inversely proportional to the curvature radius, and light emitted from a plane of emission of the propagation path becomes a plane wave.

3. The head slider according to claim 1, wherein
a refractive index of the optical layer changes in a direction of a curvature radius of the propagation path so that a phase of propagating light leads in a portion of the curvature radius smaller than that at a predetermined position of the propagation path and the phase of the propagating light lags in a portion of the curvature radius larger than that at the predetermined position of the propagation path, and
a wave surface in the direction of curvature radius of light being emitted in a plane of emission of the propagation path is like an arc.

4. The head slider according to claim 1, wherein
the optical layer has a uniform thickness along the propagation path.

5. The head slider according to claim 1, wherein
the optical layer has a thickness changing from a plane of incidence where light is incident along the propagation path.

6. The head slider according to claim 1, wherein
the optical layer is a multilayer in which a plurality of films is laminated, and
the multilayer has a refractive index changing in accordance with a curvature radius.

7. The head slider according to claim 1, wherein
the optical layer has a plane of incidence halfway through a curved surface of the slider main body.

8. The head slider according to claim 1, wherein
an optical waveguide is formed inside a recess provided on the top surface of the slider main body, and
the optical waveguide is connected to the optical layer.

9. The head slider according to claim 8, wherein
the recess is a groove formed on the top surface of the slider main body and extending from a front end to a rear end of the slider main body.

10. The head slider according to claim 9, wherein
the bottom surface of the groove is inclined so that the groove is deeper at the front end of the slider main body.

11. The head slider according to claim 8, wherein
the recess is a space formed between gimbal mounting members provided on the top surface of the slider main body, and
when a gimbal is mounted on the slider main body, the optical waveguide extends between the gimbal and the slider main body.

12. The head slider according to claim 11, wherein
a thickness of the gimbal mounting members increases toward the front end of the slider main body so that the recess becomes deeper at the front end of the slider main body.

13. The head slider according to claim 8, wherein
the recess has a V-shaped cross section and is configured to house an optical fiber.

14. The head slider according to claim 1, wherein
the curved surface is a concave surface formed on an end surface of the slider main body.
